(19) United States
(12) Patent Application Publication
(10) Pub. No.: US 2010/0322086 A1
(43) Pub. Date: Dec. 23, 2010

(54) ENABLING BUFFER STATUS REPORTS IN A COMMUNICATION SYSTEM

(75) Inventors: John M. Harris, Glenview, IL (US); Igor Filipovich, Chicago, IL (US); Rangsan Leelahakriengkrai, Streamwood, IL (US); Ivan N. Vukovic, Arlington Heights, IL (US)

Correspondence Address: MOTOROLA, INC.;Penny Tomko, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/485,988

(22) Filed: Jun. 17, 2009

(51) Int. Cl. H04L 12/26; H04L 1/18

(52) U.S. Cl. 370/252; 714/749

(57) ABSTRACT

An apparatus and method for enabling Buffer Status Reports in a Long Term Evolution communication system includes a step (400) of determining a higher than normal likelihood of receiving a first buffer status report on a first uplink grant. A next step (402) includes increasing a reliability of the first uplink grant in response the higher than normal likelihood. Other next steps can include detecting (404) that the first Buffer Status Report transmission Hybrid Automatic Repeat Request process failed and triggering (406) a second Buffer Status Report transmission in the user equipment in a next uplink grant.

### TECHNICAL FIELD OF THE INVENTION

This invention relates generally to wireless communication systems and more particularly to enabling Buffer Status Reports in a wireless communication system.

### BACKGROUND OF THE INVENTION

Currently 3rd generation (3G) cellular communication systems based on Code Division Multiple Access (CDMA) technology, such as the Universal Mobile Telecommunication System (UMTS) or 4G Long Term Evolution (LTE), are being deployed in order to accommodate the needs of various users. For example, an evolved NodeB (eNB) may be deployed in order to serve many diverse users having different communication requirements. Of course, quality of service for these users is an important consideration, including meeting delay requirements and providing priority service for preferred users. In order to accommodate these different needs in an uplink for example, it is important for the eNB to know how many bytes each user equipment needs to transmit along with any priority associated with these bytes.

At present for LTE protocols, user equipment can periodically, or in accordance with a regular protocol, provide a Buffer Status Report (BSR) indicating how many bytes it has in each of four logical channel groups (LCG). However, within the LTE protocols, a user equipment (UE) is required to, and allowed to, transmit its BSR only in very specific situations, and the eNB may not receive BSR information at the time it actually needs this information. Without this BSR information the eNB has difficulty meeting the delay requirements of different services, while not wasting capacity over assigning resources. For example, if the eNB does not have the BSR information, it will not know how much data a UE wishes to transmit, and the eNB will end up over granting resources that may not be needed, resulting in delayed communications for other UEs.

A problem arises where the UE fails to deliver a BSR. Specifically, when the UE transmission of a BSR fails (within a Hybrid Automatic Repeat Request (HARQ) process/on the last HARQ attempt), with few exceptions the UE cannot transmit the BSR again when it receives the uplink next grant, but instead would just transmit data. This is particularly problematic when the overall HARQ reliability is lower.

What is needed is a technique for enabling a non-regular BSR where a UE fails in its attempt to transmit a regular BSR. It would also be of benefit to enable such non-regular BSR without the need for a scheduling request for another uplink grant.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 illustrates a communication apparatus, in accordance with a first embodiment of the present invention;

FIG. 2 illustrates a call flow, in accordance with the first embodiment of the present invention;

FIG. 3 illustrates a call flow, in accordance with the second embodiment of the present invention; and

FIG. 4 illustrates a flow chart for a method, in accordance with the third embodiment of the present invention.

Skilled artisans will appreciate that common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENT

The present invention provides a technique for enabling a non-regular Buffer Status Report (BSR) where a user equipment (UE) fails in its attempt to transmit a regular BSR. In addition, the present invention enables such non-regular BSR without the need for a scheduling request for another uplink grant.

The following description focuses on embodiments of the invention applicable to a CDMA cellular communication system and in particular to a 3rd Generation Cellular communication system such as a High Speed Packet Access (HSPA) UMTS System or a 4^{th} Generation cellular communication system such as a Long Term Evolution (LTE) and WiMAX. However, it will be appreciated that the invention is not limited to these applications but may be applied to many other cellular communication systems. Also, the description will focus on scenarios of a serving evolved NodeB (eNB) and a served UE. However, it will be appreciated that the described principles apply equally to other hierarchical scenarios.

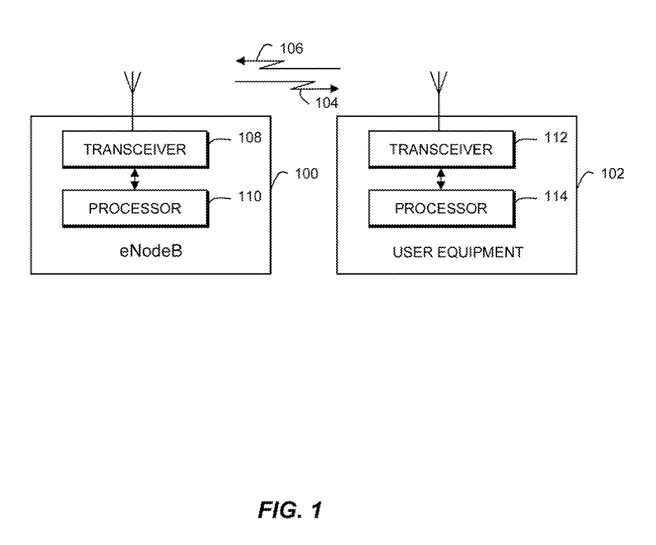

FIG. 1 illustrates an example of a wireless cellular communication system, which in this specific example is a 4G LTE cellular communication system. A serving eNB 100 is able to communicate with at least one served UE 102. The serving eNB 100 includes a processor 110 and transceiver 108. The served user equipment 102 also includes a processor 114 and transceiver 112. In this example, the processor 114 of the UE 102 has new data that it wants to upload to the eNB 100 (triggering the need for a regular BSR). The UE 102 requests scheduling from the eNB 100 in order to communicate this BSR on an uplink to the eNB 100 through its transceiver 112. The processor 110 of the eNB 100 then sends an uplink (UL) grant 104 via its transceiver 108 that assigns the UE specific Media Access Control (MAC) uplink frames to access for its BSR transmissions. However, if the transceiver of the UE fails to properly deliver its BSR 106, the processor of the eNB 100 will then not know how much uplink resources to schedule for the UE's subsequent data transmissions, and therefore the eNB can only over grant an uplink schedule for the UE's uplink data in order to minimize the possibility of losing data.

In addition, it may be that the new data is a high priority packet with a 50 ms delay budget, for example. If the eNB is using a “best effort” ongoing service, and the BSR from the UE is lost, the eNB network might not schedule additional best effort data for a few hundred milliseconds, or until a BSR retransmission timer expires. In this case, the new data will have significantly missed its delay budget. It should be noted that a short periodic BSR timer will not avoid this scenario as a periodic BSR only triggers a BSR when a grant is sent on the downlink.

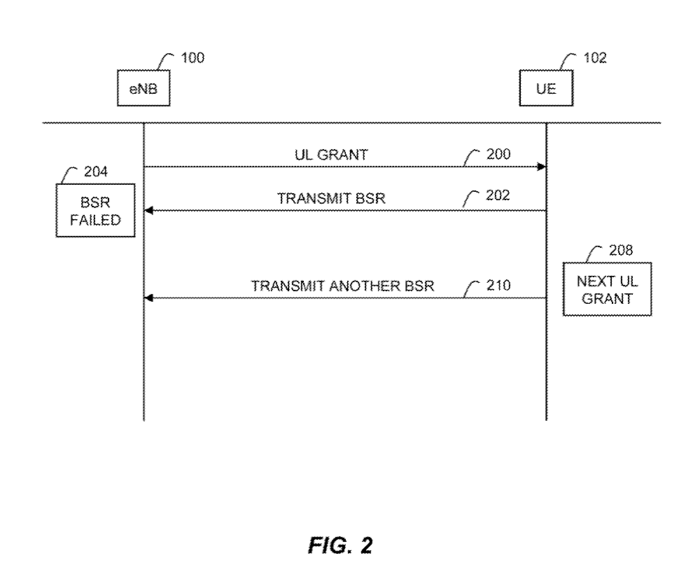

Referring to FIG. 2, in a first embodiment, where a regular BSR fails, the present invention enables a non-regular BSR in a next uplink (UL) grant without requiring a Scheduling Request/Scheduling Request Indicator (SRI) from the UE. For example, if the Hybrid Automatic Repeat Request (HARQ) of the regular BSR transmission fails, the eNB network will know that the HARQ failed and can schedule another UL grant without needing a scheduling request from the UE.

In particular, the eNB 100 will send a UL grant 200 to the UE 102, such that the UE will know when and how to transmit its BSR telling the eNB how much data it has to transfer. The UE 102 then transmits its BSR 202. If the BSR transmission is successfully transferred, then there is no issue. However, in this embodiment it is assumed that the BSR transmission failed 204. The eNB knows that the uplink HARQ process failed, so it may send another uplink grant, but—without the present invention—the UE in many cases (e.g. before the PERIODIC_BSR_TIMER expires) will not include a BSR in the next uplink grant. As the UE will recognize this failure, the UE autonomously determines to trigger the BSR based on the conditions specified, so that the eNB does not need to transmit an explicit indicator to trigger the BSR in the situation. The only indication in the situation is the last HARQ Not Acknowledged (HARQ NAK), which the eNB transmits to the UE for the very last HARQ attempt. The UE 102 can then send another BSR 210 on the next UL grant 208 as long as the original BSR was reporting a positive number of bytes, i.e. is not a padding BSR with all zeros. In addition, the BSR need not be resent if a subsequent BSR has been triggered (after the initial BSR was transmitted) and this subsequent BSR has already begun transmission, e.g., has sent its first HARQ attempt).

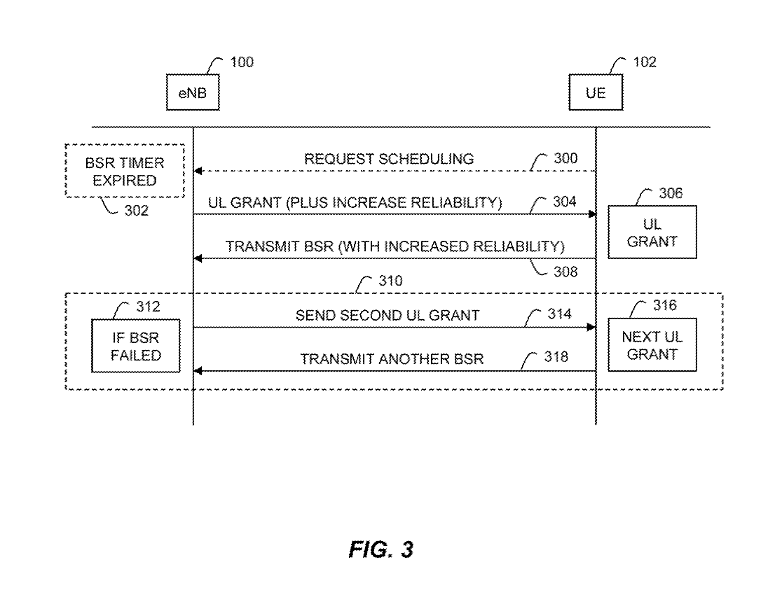

Referring to FIG. 3, in a second embodiment, the present invention can enable a non-regular BSR for the next uplink grant immediately after it receives a schedule request (SR/SRI), or if a periodic BSR timer expires. If either of these conditions exists, this embodiment can perform at least one of: targeting a higher reliability (more robust MCS or more HARQ attempts) for the non-regular BSR transmission, and transmitting a second uplink assignment, if the first uplink assignment fails.

In particular, upon a UE 102 requesting scheduling 300 or upon a periodic BSR timer expiring 302, an eNB 100 will send a UL grant 304 to the UE 102, such that the UE will know when and how to transmit its BSR telling the eNB how much data it has to transfer. The UL grant message 304 can optionally include instructions for increasing the reliability of the BSR transmission. Upon receiving the UL grant 306, the UE 102 will transmit its BSR 308 (with increased reliability if such was granted in the UL grant 304). If the BSR transmission is successfully transferred, then there is no issue. However, in this embodiment it is assumed that the BSR transmission failed 312, which triggers more actions 310. As the eNB 100 will recognize this failure, it will trigger another BSR and send another UL grant 314 for this BSR. The UE 102 will then resend another BSR 318 on the next UL grant 316 as long as the BSR has some positive bytes, i.e. is not a padding BSR with all zeros. In addition, the BSR need not be resent if a subsequent BSR has been triggered (after the initial BSR was transmitted) and this subsequent BSR has already begun transmission, e.g., has sent its first HARQ attempt).

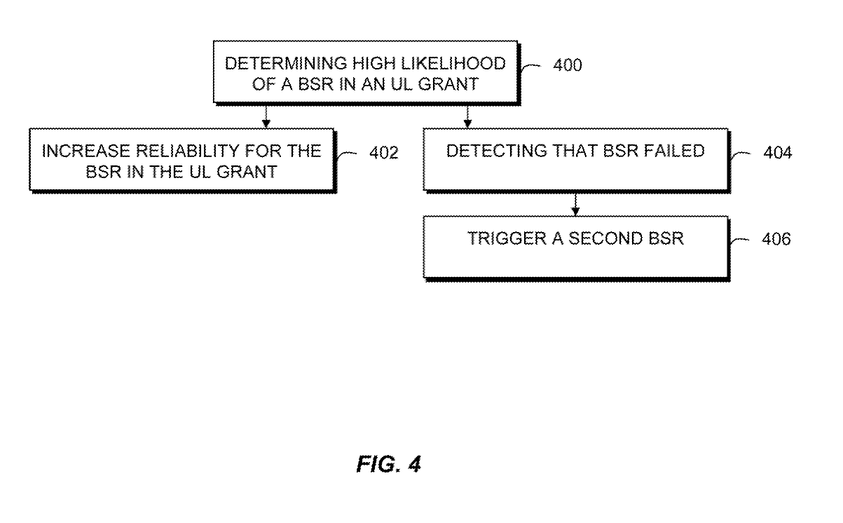

Referring to FIG. 4, the present invention also provides a method for enabling Buffer Status Reports in a Long Term Evolution communication system. The method includes a step 400 of determining a higher than normal likelihood of receiving a first buffer status report on a first uplink grant. A normal likelihood is expected for “regular” BSR reporting for existing LTE protocols. A higher likelihood is expected, for example, when a Periodic Buffer Status Report Timer is expiring or when the UE sends a scheduling request to the eNB and the scheduled uplink grant is the next uplink grant after the scheduling request.

A next step 402 could then include increasing a reliability of the first uplink grant. In particular, this could include; selecting a more reliable modulation and coding scheme for the first uplink grant, increasing a maximum number of HARQ attempts for the BSR in the first uplink grant, and/or selecting a higher transmission power for the BSR in the first uplink grant.

A next step 404 could also include detecting that a Buffer Status Report transmission from a user equipment has failed. In particular, a failure occurs when a Hybrid Automatic Repeat Request process failed during the Buffer Status Report transmission. In this case, a next step 406 would include triggering another Buffer Status Report transmission in the user equipment in a next uplink grant.

In the first embodiment, the Buffer Status Report transmission is triggered without a scheduling request or scheduling request indicator from the user equipment. Preferably, this step only occurs if the Buffer Status Report is not a padded Buffer Status Report, a Buffer Status Report reporting a total of zero bytes, or if a Buffer Status Report subsequent to the first uplink grant was not already triggered and has begun transmission.

In the second embodiment, where a Periodic Buffer Status Report Timer is expiring, this step includes triggering another Buffer Status Report transmission in a next uplink grant after the Periodic Buffer Status Report Timer has expired, or where a scheduling request has been received from the user equipment, this step includes triggering another Buffer Status Report transmission in a next uplink grant immediately after the scheduling request.

In LTE practice, the Buffer Status Report transmission is a “regular” Buffer Status Report transmission in Long Term Evolution protocols, and in the triggering step the another Buffer Status Report transmission is a “non-regular” Buffer Status Report transmission introduced by the present invention into Long Term Evolution protocols.

The present invention provides the advantage of enhancing the delay performance capacity of a communication system pursuant to the above embodiments. Notwithstanding the stated benefits, the embodiments described herein can be realized with only minimal changes to the relevant 3GPP, 3GPP2, and 802.16 standards. It will be understood that the terms and expressions used herein have the ordinary meaning as is accorded to such terms and expressions by persons skilled in the field of the invention as set forth above except where specific meanings have otherwise been set forth herein.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including use of hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, an “first”, “second” etc do not preclude a plurality.

While the invention may be susceptible to various modifications and alternative forms, a specific embodiment has been shown by way of example in the drawings and has been described in detail herein. However, it should be understood that the invention is not intended to be limited to the particular forms disclosed, and can be applied equally well to any communication system that can use real-time services. Rather, the invention is to cover all modification, equivalents and alternatives falling within the scope of the invention as defined by the following appended claims.

What is claimed is:

1. A method for enabling Buffer Status Reports in a communication system, the method comprising the steps of:
determining a higher than normal likelihood of receiving a first buffer status report on a first uplink grant; and
performing at least one of:
in response the higher than normal likelihood, increasing a reliability of the first uplink grant, and
in response to detecting that at least one of the last or the next-to-last Hybrid Automatic Repeat Request attempt failed for the first Buffer Status Report transmission, triggering a second Buffer Status Report transmission in the user equipment in a next uplink grant.

2. The method of claim 1 wherein the step of increasing includes increasing the reliability of the first uplink grant by selecting a more reliable modulation and coding scheme.

3. The method of claim 1 wherein the step of increasing includes increasing the reliability of the first uplink grant by increasing a maximum number of HARQ attempts.

4. The method of claim 1 wherein the step of increasing includes increasing the reliability of the first uplink grant by selecting a higher transmission power.

5. The method of claim 1 wherein the determining step includes determining a high likelihood by determining that a scheduled uplink grant is the next grant after a scheduling request.

6. The method of claim 1 wherein the determining step includes determining a high likelihood by determining that a PERIODIC_BSR_TIMER is expiring.

7. The method of claim 6, wherein the triggering step includes triggering the second Buffer Status Report transmission in a next uplink grant after the Periodic Buffer Status Report Timer has expired.

8. The method of claim 1, wherein the in triggering step the second Buffer Status Report transmission is triggered without a scheduling request from the user equipment.

9. The method of claim 1, wherein the triggering step only occurs if the first Buffer Status Report is not a Padding Buffer Status Report.

10. The method of claim 1, wherein the triggering step only occurs if the first Buffer Status Report is not a buffer status report reporting a total of zero bytes.

11. The method of claim 1, wherein the triggering step only occurs if a Buffer Status Report subsequent to the first uplink grant was not already triggered and has begun transmission.

12. The method of claim 1, wherein in the determining step the first Buffer Status Report transmission is a regular Buffer Status Report transmission in Long Term Evolution protocols, and in the triggering step the second Buffer Status Report transmission is a non-regular Buffer Status Report transmission in Long Term Evolution protocols.

13. The method of claim 1, wherein the detecting step occurs within a user equipment.

14. The method of claim 1, wherein the increasing step occurs within an evolved NodeB.

15. An evolved NodeB operable to enable Buffer Status Reports in a communication system, the evolved NodeB comprising:
a processor coupled to a transceiver, the processor operable to determine a higher than normal likelihood of receiving a first buffer status report on a first uplink grant and to perform at least one of:
increasing a reliability of the first uplink grant in response the higher than normal likelihood, and
triggering a second Buffer Status Report transmission in the user equipment in a next uplink grant in response to detecting that a Buffer Status Report transmission Hybrid Automatic Repeat Request process from a user equipment has failed.
